(19) United States
(12) Patent Application Publication
(10) Pub. No.: US 2024/0389184 A1
(43) Pub. Date: Nov. 21, 2024

(54) METHOD AND APPARATUS FOR TRANSMITTING SEGMENTED RRC MESSAGE IN WIRELESS COMMUNICATION SYSTEM

(71) Applicant: Samsung Electronics Co., Ltd., Suwon-si, Gyeonggi-do (KR)

(72) Inventors: Sangyeob JUNG, Suwon-si (KR); Anil AGIWAL, Mountain View, CA (US)

(21) Appl. No.: 18/667,412

(22) Filed: May 17, 2024

Related U.S. Application Data
(60) Provisional application No. 63/467,162, filed on May 17, 2023.

(51) Int. Cl. H04W 76/20; H04L 5/00; H04W 36/08

(52) U.S. Cl. CPC H04W 76/20; H04L 5/0053; H04W 36/08

(57) ABSTRACT

The disclosure relates to a 5G or 6G communication system for supporting a higher data transmission rate. A method performed by a terminal in a wireless communication system is provided. The method includes transmitting, to a first base station, a first segment of a radio resource control (RRC) message, receiving, from the first base station, a handover command message, performing a handover to a second base station based on the handover command message, transmitting, to the second base station, an RRC reconfiguration complete message, and transmitting, to the second base station, a second segment of the RRC message.

### CROSS-REFERENCE TO RELATED APPLICATION(S)

This application is based on and claims priority under 35 U.S.C. § 119 (e) of a U.S. Provisional application Ser. No. 63/467,162, filed on May 17, 2023, in the U.S. Patent and Trademark Office, the disclosure of which is incorporated by reference herein in its entirety.

### BACKGROUND

### 1. Field

The disclosure relates to a wireless communication system. More particularly, the disclosure relates to a method for transmitting segmented radio resource control (RRC) messages in a wireless communication system.

### 2. Description Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In the handover procedure of a wireless communication system, there is a need for a method for a terminal to more efficiently transmit segmented RRC messages.

Aspects of the disclosure are to address at least the above-mentioned problems and/or disadvantages and to provide at least the advantages described below. Accordingly, an aspect of the disclosure is to provide a method for transmitting segmented RRC messages in a wireless communication system.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes transmitting, to a first base station, a first segment of a radio resource control (RRC) message, receiving, from the first base station, a handover command message, performing a handover to a second base station based on the handover command, transmitting, to the second base station, an RRC reconfiguration complete message, and transmitting, to the second base station, a second segment of the RRC message.

In accordance with another aspect of the disclosure, a method performed by a second base station in a wireless communication system is provided. The method includes receiving, from a first base station, a handover request message including a first segment of a radio resource control (RRC) message associated with a terminal, transmitting, to the first base station, a handover request acknowledgement message, after a handover of the terminal to the second base station, receiving, from the terminal an RRC reconfiguration complete message, and receiving, from the terminal, a second segment of the RRC message.

In accordance with another aspect of the disclosure, a terminal in a wireless communication system is provided. The terminal includes a transceiver, memory storing one or more computer programs, and one or more processors communicatively coupled with the transceiver and the memory, wherein the one or more computer programs include computer-executable instructions that, when executed by the one or more processors, cause the terminal to transmit, to a first base station, a first segment of a radio resource control (RRC) message, receive, from the first base station, a handover command message, perform a handover to a second base station based on the handover command message, transmit, to the second base station, an RRC reconfiguration complete message, and transmit, to the second base station, a second segment of the RRC message.

In accordance with another aspect of the disclosure, a second base station in a wireless communication system is provided. The second base station includes a transceiver, memory storing one or more computer programs, and one or more processors communicatively coupled with the transceiver and the memory, wherein the one or more computer programs include computer-executable instructions that, when executed by the one or more processors, cause the second base station to receive, from a first base station, a handover request message including a first segment of a radio resource control (RRC) message associated with a terminal, transmit, to the first base station, a handover request acknowledgement message, after a handover of the terminal to the second base station, receive, from the terminal an RRC reconfiguration complete message, and receive, from the terminal, a second segment of the RRC message.

In accordance with another aspect of the disclosure, one or more non-transitory computer-readable storage media storing computer-executable instructions that, when executed by one or more processors of a terminal, cause the terminal to perform operations are provided. The operations include transmitting, to a first base station, a first segment of a radio resource control (RRC) message, receiving, from the first base station, a handover command message, performing a handover to a second base station based on the handover command message, transmitting, to the second base station, an RRC reconfiguration complete message, and transmitting, to the second base station, a second segment of the RRC message.

According to an embodiment of the disclosure, it is possible to reduce the processing load of a terminal and a base station and save network resources by preventing the terminal from redundantly transmitting segmented RRC messages during the handover procedure of a wireless communication system.

According to an embodiment of the disclosure, it is possible to secure network stability by transmitting segmented RRC messages without loss by a terminal during the handover procedure of a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a long term evolution (LTE) system according to an embodiment of the disclosure;

FIG. 2 is a diagram illustrating a radio protocol structure of an LTE system according to an embodiment of the disclosure;

FIG. 3 is a diagram illustrating a structure of a next-generation mobile communication system according to an embodiment of the disclosure;

FIG. 4 is a diagram illustrating a radio protocol structure of a next-generation mobile communication system according to an embodiment of the disclosure;

FIG. 5A is a flowchart of a process in which a terminal transmits a segmented RRC message to a base station in a wireless communication system according to an embodiment of the disclosure;

FIG. 5B is a flowchart of a process in which a terminal transmits a segmented RRC message to a base station in a wireless communication system according to an embodiment of the disclosure;

FIG. 6A is a flowchart of a process in which a terminal transmits a segmented RRC message to a base station in a wireless communication system according to an embodiment of the disclosure;

FIG. 6B is a flowchart of a process in which a terminal transmits a segmented RRC message to a base station in a wireless communication system according to an embodiment of the disclosure;

FIG. 7A is a flowchart of a process in which a terminal transmits a segmented RRC message to a base station in a wireless communication system according to an embodiment of the disclosure;

FIG. 7B is a flowchart of a process in which a terminal transmits a segmented RRC message to a base station in a wireless communication system according to an embodiment of the disclosure;

FIG. 8A is a flowchart of a process in which a terminal transmits a segmented RRC message to a base station in a wireless communication system according to an embodiment of the disclosure;

FIG. 8B is a flowchart of a process in which a terminal transmits a segmented RRC message to a base station in a wireless communication system according to an embodiment of the disclosure;

FIG. 9 is a block diagram illustrating the internal structure of a terminal according to an embodiment of the disclosure; and

FIG. 10 is a block diagram illustrating the configuration of an NR base station according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description of the disclosure, detailed descriptions of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description of the disclosure, terms and names defined in the 3rd generation partnership project long term evolution (3GPP LTE) or new radio (NR) standards will be used for the sake of descriptive convenience. However, the disclosure is not limited by these terms and names, and may be applied in the same way to systems that conform other standards. In the disclosure, the term “eNB” may be interchangeably used with the term “gNB” for the sake of descriptive convenience. For example, a base station described as “eNB” may indicate “gNB”.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

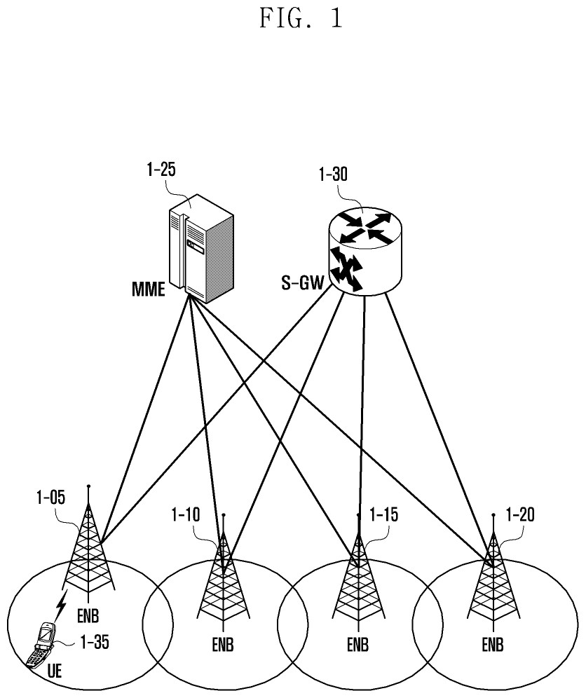

FIG. 1 illustrates a structure of an LTE system according to an embodiment of the disclosure.

Referring to FIG. 1, as illustrated therein, a radio access network (RAN) of an LTE system includes next-generation base stations (evolved node Bs, hereinafter ENBs, node Bs, or base stations) 1-05, 1-10, 1-15, and 1-20, a mobility management entity (MME) 1-25, and a serving gateway (S-GW) 1-30. A user equipment (hereinafter UE or terminal) 1-35 accesses an external network through the ENBs 1-05 to 1-20 and the S-GW 1-30.

In FIG. 1, the ENBs 1-05 to 1-20 each correspond to a node B of the related art in a universal mobile telecommunications system (UMTS) system. The ENBs are connected to the UE 1-35 through a radio channel, and perform more complicated roles than the node Bs of the related art. In the LTE system, since all user traffic including real-time services, such as voice over Internet protocol (VOIP) via the Internet protocol, is serviced through a shared channel, a device that collects state information, such as buffer states, available transmit power states, and channel states of UEs, and performs scheduling accordingly is required, and the ENBs 1-05 to 1-20 serves as the device. In general, one ENB controls multiple cells. For example, in order to implement a transfer rate of 100 Mbps, the LTE system uses orthogonal frequency division multiplexing (hereinafter referred to as OFDM) as a radio access technology in a bandwidth of, for example, 20 MHz. Furthermore, the LTE system employs an adaptive modulation & coding (hereinafter referred to as AMC) scheme for determining a modulation scheme and a channel coding rate according to a channel state of the UE. The S-GW 1-30 is a device that provides a data bearer, and generates or removes a data bearer under the control of the MME 1-25. The MME is responsible for various control functions as well as a mobility management function for a UE, and is connected to multiple base stations.

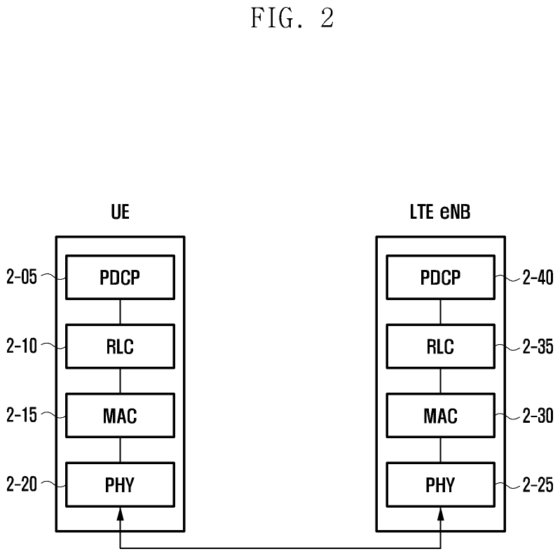

FIG. 2 illustrates a radio protocol structure of an LTE system according to an embodiment of the disclosure.

Referring to FIG. 2, a radio protocol of an LTE system includes a packet data convergence protocol (PDCP) 2-05 or 2-40, a radio link control (RLC) 2-10 or 2-35, and a medium access control (MAC) 2-15 or 2-30 in each of a UE and an ENB. The packet data convergence protocol (PDCP) 2-05 or 2-40 is responsible for operations, such as IP header compression/reconstruction. The main functions of the PDCP are summarized as follows.
Header compression and decompression: robust header compression (ROHC) only
Transfer of user data
In-sequence delivery of upper layer protocol data units (PDUs) at PDCP re-establishment procedure for RLC acknowledged mode (AM)
For split bearers in dual connectivity (DC) (only support for RLC AM): PDCP PDU routing for transmission and PDCP PDU reordering for reception
Duplicate detection of lower layer service data units (SDUs) at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (hereinafter referred to as RLC) 2-10 or 2-35 reconfigures a PDCP protocol data unit (PDU) into an appropriate size to perform an automatic repeat request (ARQ) operation, or the like. The main functions of the RLC are summarized as follows.
Transfer of upper layer PDUs
Error Correction through ARQ (only for AM data transfer)
Concatenation, segmentation and reassembly of RLC SDUs (only for unacknowledged mode (UM) and AM data transfer)
Re-segmentation of RLC data PDUs (only for AM data transfer)
Reordering of RLC data PDUs (only for UM and AM data transfer)
Duplicate detection (only for UM and AM data transfer)
Protocol error detection (only for AM data transfer)
RLC SDU discard (only for UM and AM data transfer)
RLC re-establishment

The MAC 2-15 or 2-30 is connected to several RLC layer devices configured in a single terminal, and multiplexes RLC PDUs into a MAC PDU and demultiplexes a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through hybrid ARQ (HARQ)
Priority handling between logical channels of one UE
Priority handling between UEs by means of dynamic scheduling
Multimedia broadcast multicast service (MBMS) service identification
Transport format selection
Padding

A physical layer 2-20 or 2-25 performs operations of channel-coding and modulating upper layer data, generating the same into OFDM symbols, and transmitting the same through a radio channel, or demodulating the OFDM symbols received through the radio channel, channel-decoding the same, and delivering the same to the upper layer.

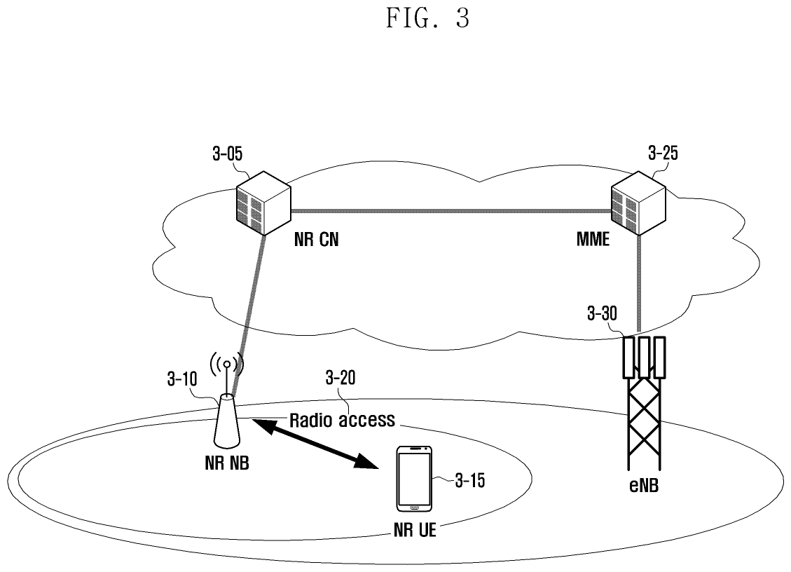

FIG. 3 illustrates a structure of a next-generation mobile communication system according to an embodiment of the disclosure.

Referring to FIG. 3, as illustrated therein, a radio access network of a next-generation mobile communication system (hereinafter NR or 5G) includes a next-generation base station (new radio node B, hereinafter NR gNB or NR base station) 3-10, and a new radio core network (NR CN) 3-05. A user terminal (new radio user equipment, hereinafter NR UE or NR terminal) 3-15 accesses an external network via the NR gNB 3-10 and the NR CN 3-05.

In FIG. 3, the NR gNB 3-10 corresponds to an evolved node B (eNB) of an LTE system of the related art. The NR gNB may be connected to the NR UE 3-15 through a radio channel and provide outstanding services as compared to a node B of the related art. In the next-generation mobile communication system, since all user traffic is serviced through a shared channel, a device that collects state information, such as buffer statuses, available transmit power states, and channel states of UEs, and performs scheduling accordingly is required, and the NR gNB 3-10 serves as the device. In general, one NR gNB controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The NR CN 3-05 performs functions, such as mobility support, bearer configuration, and quality of service (QOS) configuration. The NR CN is a device responsible for various control functions as well as a mobility management function for a UE, and is connected to multiple base stations. In addition, the next-generation mobile communication system may interwork with the existing LTE system, and the NR CN may be connected to an MME 3-25 via a network interface. The MME is connected to an eNB 3-30 that is an existing base station in a network 3-20.

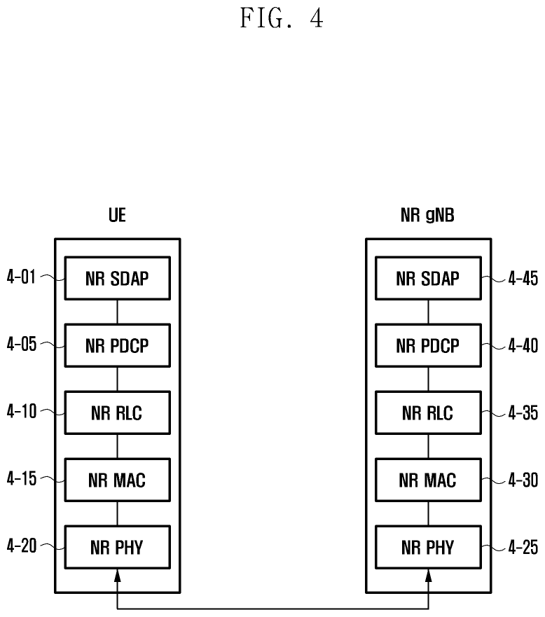

FIG. 4 illustrates a radio protocol structure of a next-generation mobile communication system according to an embodiment of the disclosure.

Referring to FIG. 4, a radio protocol of a next-generation mobile communication system includes an NR service data adaptation protocol (SDAP) 4-01 or 4-45, an NR PDCP 4-05 or 4-40, an NR RLC 4-10 or 4-35, and an NR MAC 4-15 or 4-30 in each of a UE and an NR base station.

The main functions of the NR SDAP 4-01 or 4-45 may include some of functions below.
Transfer of user plane data
Mapping between a QoS flow and a data radio bearer (DRB) for both DL and UL
Marking QoS flow ID in both DL and UL packets
Reflective QoS flow to DRB mapping for the UL SDAP PDUs

With regard to the SDAP layer device, the UE may be configured, through an RRC message, whether to use the header of the SDAP layer device or whether to use functions of the SDAP layer device for each PDCP layer device or each bearer or each logical channel. If an SDAP header is configured, the non-access stratum (NAS) QoS reflection configuration 1-bit indicator (NAS reflective QoS) and the AS QoS reflection configuration 1-bit indicator (AS reflective QoS) of the SDAP header may be indicated so that the UE can update or reconfigure mapping information regarding the QoS flow and data bearer of the uplink and downlink. The SDAP header may include QoS flow ID information indicating the QoS. The QoS information may be used as data processing priority for providing efficient services, scheduling information, or the like.

The main functions of the NR PDCP 4-05 or 4-40 may include some of following below.
Header compression and decompression: ROHC only
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

The reordering of the NR PDCP device refers to a function of reordering PDCP PDU received from a lower layer in an order based on PDCP sequence numbers (SNs), and may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 4-10 or 4-35 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

The in-sequence delivery of the NR RLC device refers to a function of transferring RLC SDUs received from a lower layer to an upper layer in sequence, and may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, may include a function of requesting retransmission of lost RLC PDUs, may include a function of, if there is a lost RLC SDU, sequentially transferring only RLC SDUs before the lost RLC SDU to an upper layer, may include a function of, although there is a lost RLC SDU, if a predetermined timer has expired, sequentially transferring, to an upper layer, all the RLC SDUs received before the timer is started, or may include a function of, although there is a lost RLC SDU, if a predetermined timer has expired, sequentially transferring all the RLC SDUs received up to the current, to an upper layer. In addition, the RLC PDUs may be processed in the received order (regardless of the sequence number order, in the order of arrival) and delivered to the PDCP device regardless of the order (out-of-sequence delivery), and in the case of segments, segments which are stored in a buffer or are to be received later may be received, reconfigured into one complete RLC PDU, processed, and delivered to the PDCP device. The NR RLC layer may include no concatenation function, which may be performed in the NR MAC layer or replaced with a multiplexing function of the NR MAC layer.

The out-of-sequence delivery function of the NR RLC device refers to a function of instantly delivering RLC SDUs received from the lower layer to the upper layer regardless of the order, may include a function of, if multiple RLC SDUs into which one original RLC SDU has been segmented are received, reassembling and delivering the same, and may include a function of storing the RLC SN or PDCP SN of received RLC PDUs, and recording RLC PDUs lost as a result of reordering.

The NR MAC 4-15 or 4-30 may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY layer 4-20 or 4-25 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

In various embodiments of the disclosure, “application measurement” may refer to measuring quality of experience (QoE) for a specific application in the application layer of a terminal. The QoE measurement may be performed based on configuration information received from an operations administration and maintenance (OAM) and/or a core network (CN) and/or a base station. The access stratum (AS) layer, which receives the QoE measurement results from the application layer, may report the measurement results to the base station through an RRC message (e.g., a MeasurementReportAppLayer message). The QoE measurement result included in the RRC message may be forwarded to the OAM and/or TCE and/or MCE without being decoded by the base station. Alternatively, when the QoE measurement result includes RAN-visible measurement, the base station may decode and use the QoE measurement result. The terminal may transmit the RRC message through signaling radio bearer 4 (SRB4). In addition, in various embodiments of the disclosure, although uplink RRC segmentation for the MeasurementReportAppLayer message is described as an example, the target of the uplink RRC segmentation performed by the terminal is not limited to the MeasurementReportAppLayer message, but may also be applied to other RRC messages transmitted by the terminal to the base station.

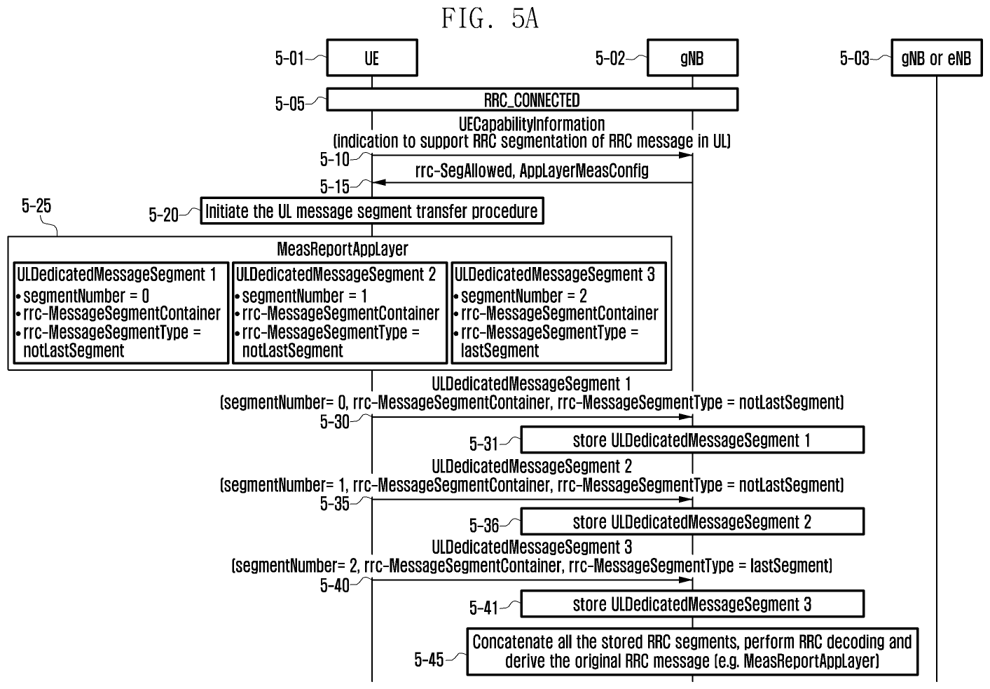

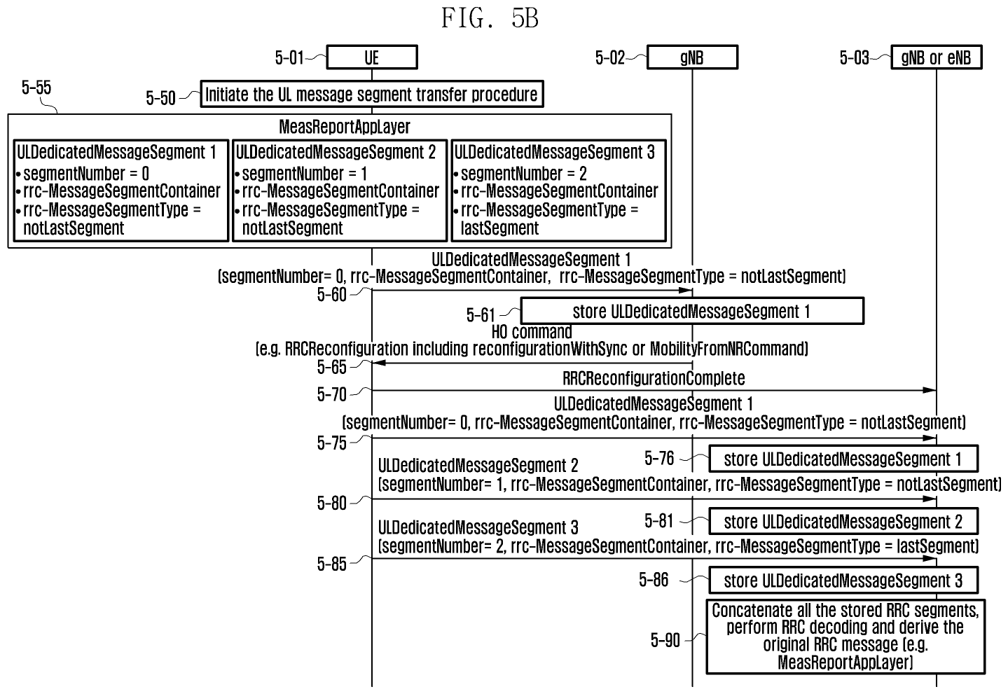

FIGS. 5A and 5B are flowcharts of a process in which a terminal transmits a segmented RRC message to a base station in a wireless communication system according to various embodiments of the disclosure.

The terminal according to the disclosure may transmit a segmented RRC message to the base station. When the size of an encoded RRC message is larger than the maximum supported size of a PDCP SDU, the terminal that is configured to allow RRC message segmentation (rrc-SegAllowed) from the base station may transmit a segmented RRC message to the base station through ULDedicatedMessageSegment. However, when a handover occurs, the terminal may delete all previously transmitted RRC segments and transmit segmented RRC messages again from the beginning to the target cell after the handover.

Referring to FIGS. 5A and 5B, in operation 5-05, a terminal 5-01 may establish an RRC connection with an NR base station 5-02 and be in the RRC connected mode (RRC_CONNECTED).

In operation 5-10, the terminal 5-01 may transmit a terminal capability information message (UECapabilityInformation) to the base station 5-02. The message may include capability information indicating whether the terminal supports uplink RRC segmentation for the RRC message. As an example, the message may include capability information (ul-RRC-Segmentation) indicating that uplink RRC segmentation for UECapabilityInformation is supported and/or capability information (ul-MeasurementReportAppLayer-Seg) indicating that uplink RRC segmentation for the MeasurementReportAppLayer message is required.

In operation 5-15, the base station 5-02 may configure rrc-SegAllowed to the terminal 5-01 through the RRC message. The RRC message may refer to an RRC reconfiguration message (RRCReconfiguration), an RRC resume message (RRCResume), a UE capability enquiry message (UECapabilityEnquiry) or the like. The RRC message may include configuration information (AppLayerMeasConfig) for application layer measurement.

In operation 5-20, the terminal 5-01 may initiate a UL message segment transfer procedure to transmit the application measurement result to the base station 5-02. For example, when the size of the encoded RRC message to be transmitted by the terminal is larger than the maximum supported size of one PDCP SDU, and when it is configured by the base station that the RRC message segmentation is enabled, the terminal may initiate the UL message segment transfer procedure.

In operation 5-25, the terminal 5-01 may segment the RRC message (e.g., a MeasurementReportAppLayer message) to be transmitted according to the following procedure to set the content of the ULDedicatedMessageSegment message.
For each new UL dedicated control channel (DCCH) message, set the segmentNumber to 0 for the first message segment and increment the segmentNumber for each subsequent RRC message segment.
Set rrc-MessageSegmentContainer to include the segment of the UL DCCH message corresponding to the segmentNumber.
When the last segment of the UL DCCH message is included in the rrc-MessageSegmentContainer, set rrc-MessageSegmentType to lastSegment, otherwise, set the rrc-MessageSegmentType to notLastSegment.

The terminal 5-01 may transmit all ULDedicatedMessageSegment messages for the segmented RRC message to the base station 5-02 in ascending order of segmentNumber. For example, in operation 5-30, the terminal may transmit ULDedicatedMessageSegment 1 set to segmentNumber=0 to the base station. In operation 5-31, the base station may store the received ULDedicatedMessageSegment 1. In operation 5-35, the terminal may transmit ULDedicatedMessageSegment 2 set to segmentNumber=1 to the base station. In operation 5-36, the base station may store the received ULDedicatedMessageSegment 2. In operation 5-40, the terminal may transmit ULDedicatedMessageSegment 3 set to segmentNumber=2 to the base station.

In operation 5-41, the base station may store the received ULDedicatedMessageSegment 3.

In operation 5-45, the base station that receives the ULDedicatedMessageSegment in which rrc-MessageSegmentType is set to lastSegment may concatenate the stored RRC segments and perform RRC decoding to derive the original RRC message. In the disclosure, the original RRC message may refer to the MeasurementReportAppLayer message.

In operation 5-50, the terminal 5-01 may initiate a UL message segment transfer procedure to transmit the application measurement result to the base station 5-02. This may follow operation 5-20 described above.

In operation 5-55, the terminal 5-01 may set the content of the ULDedicatedMessageSegment message by segmenting the RRC message (e.g., a MeasurementReportAppLayer message) to be transmitted according to operation 5-25 described above.

In operation 5-60, the terminal 5-01 may transmit ULDedicatedMessageSegment 1 set to segmentNumber=0 to the base station 5-02. In operation 5-61, the base station may store the received ULDedicatedMessageSegment 1.

In operation 5-65, the base station 5-02 may transmit an RRC message including a handover command to the terminal 5-01 to handover to a target base station (or target cell) 5-03. As an example, the RRC message may refer to an RRCReconfiguration message including reconfiguration WithSync or MobilityFromNRCommand.

In operation 5-70, when the terminal 5-01 performs a random access procedure to the target base station (or target cell) 5-03 and successfully performs a handover (or successfully completes the random access procedure), the terminal 5-01 may transmit an RRC message (e.g., RRCReconfigurationComplete) indicating successful completion of the random access procedure and handover to the target base station (or target cell) 5-03.

In operation 5-75, the terminal 5-01 may transmit the ULDedicatedMessageSegment message segmented in operation 5-55 for the base station 5-02 again from the beginning to the current base station 5-03. For example, in operation 5-75, the terminal may transmit ULDedicatedMessageSegment 1 set to segmentNumber=0 to the base station 5-03. In operation 5-76, the base station 5-03 may store the received ULDedicatedMessageSegment 1. In operation 5-80, the terminal may transmit ULDedicatedMessageSegment 2 set to segmentNumber=1 to the base station 5-03. In operation 5-81, the base station 5-03 may store the received ULDedicatedMessageSegment 2. In operation 5-85, the terminal may transmit ULDedicatedMessageSegment 3 set to segmentNumber=2 to the base station 5-03. In operation 5-86, the base station 5-03 may store the ULDedicatedMessageSegment 3.

In operation 5-90, the base station 5-03 that receives the ULDedicatedMessageSegment in which rrc-MessageSegmentType is set to lastSegment may concatenate the stored RRC segments and perform RRC decoding to derive the original RRC message (5-90). In the disclosure, the original RRC message may refer to the MeasurementReportAppLayer message.

According to embodiments of FIGS. 5A and 5B, even if the terminal successfully transmits some of the segmented RRC messages to the source base station before performing the handover, since the terminal needs to transmit the segmented RRC messages again from the beginning to the target base station 5-03 that performs the handover, unnecessary signaling overhead may be increased and resources may be wasted.

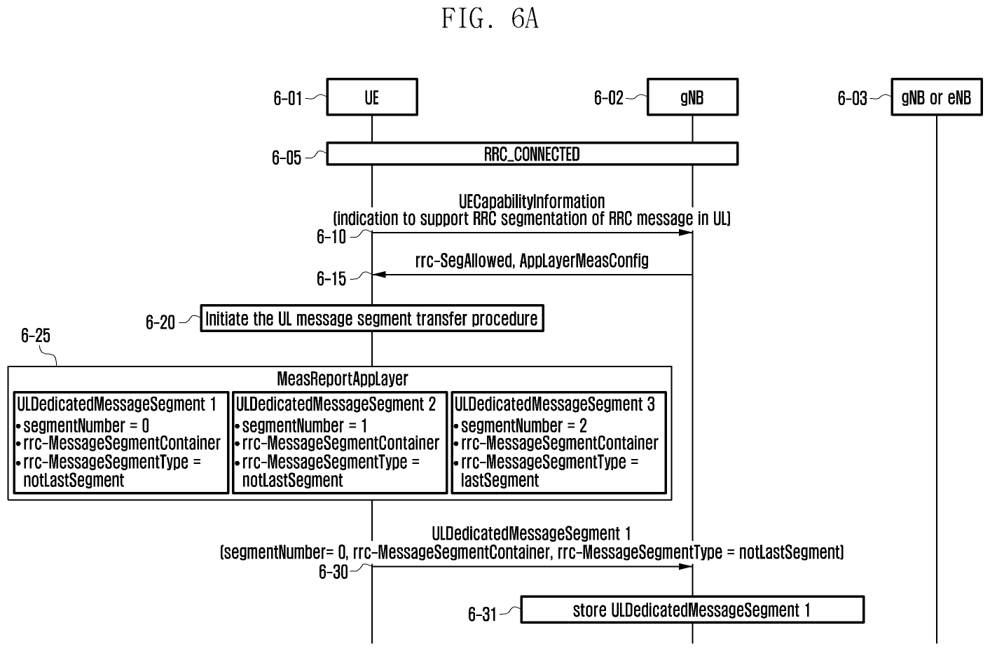

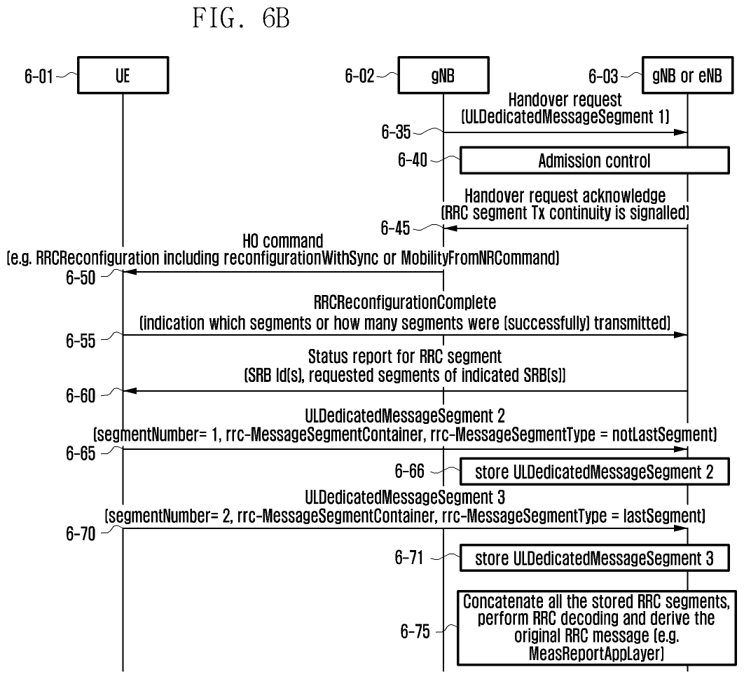

FIGS. 6A and 6B are flowcharts of a process in which a terminal transmits a segmented RRC message to a base station in a wireless communication system according to various embodiments of the disclosure.

The terminal according to the disclosure may transmit a segmented RRC message to the base station. When the size of an encoded RRC message is larger than the maximum supported size of a PDCP SDU, the terminal that is configured to allow RRC message segmentation (rrc-SegAllowed) from the base station may transmit a segmented RRC message to the base station through ULDedicatedMessageSegment. When a handover occurs, the terminal may perform transmission to the target cell, starting from the segmented RRC messages that are not (successfully) transmitted among the segmented RRC messages to the source cell, after handover. In the disclosure, the handover may refer to at least one of PCell change, PSCell addition or change, and PCell change and PSCell addition or change.

Referring to FIGS. 6A and 6B, in operation 6-05, a terminal 6-01 may establish an RRC connection with an NR base station 6-02 and be in the RRC connected mode (RRC_CONNECTED).

In operation 6-10, the terminal 6-01 may transmit a terminal capability information message (UECapabilityInformation) to the base station 6-02. Operation 6-10 may follow operation 5-10 described above. In addition, for the RRC message, the terminal capability information message may include capability information indicating that the terminal is able to transmit the RRC message after handover, starting from segmented RRC messages that are not (successfully) transmitted to the previous source cell. For example, the message may include capability information that the terminal may support RRC segment transmission continuity to the target cell even after handover.

In operation 6-15, the base station 6-02 may configure rrc-SegAllowed to the terminal 6-01 through an RRC message. The RRC message may refer to an RRC reconfiguration message (RRCReconfiguration), an RRC resume message (RRCResume), or a UE capability enquiry message (UECapabilityEnquiry). In the disclosure, for convenience of description, the RRC message may include configuration information (AppLayerMeasConfig) for application layer measurement.

In operation 6-20, the terminal 6-01 may initiate a UL message segment transfer procedure to transmit the application measurement result to the base station 6-02. For example, when the size of the encoded RRC message to be transmitted by the terminal is larger than the maximum supported size of one PDCP SDU, and when it is configured by the base station that the RRC message segmentation is enabled, the terminal may initiate the UL message segment transfer procedure.

In operation 6-25, the terminal 6-01 may segment an RRC message (e.g., a MeasurementReportAppLayer message) to be transmitted according to operation 5-25 described above to set the content of the ULDedicatedMessageSegment message.

The terminal 6-01 may transmit (all) ULDedicatedMessageSegment messages for the segmented RRC message in operation 6-20 to the base station 6-02 in ascending order of segmentNumber. In operation 6-30, the terminal may successfully transmit ULDedicatedMessageSegment 1 set to segmentNumber=0 to the base station 6-02. In operation 6-31, the base station 6-02 may store the received ULDedicatedMessageSegment 1.

The source base station 6-02 may perform a handover preparation procedure with a target base station 6-03. In operation 6-35, the source base station 6-02 may transmit a handover request message to perform handover preparation with the target base station 6-03. The message may include ULDedicatedMessageSegment 1 stored in operation 6-31. In operation 6-40, the target base station 6-03 may perform admission control. In operation 6-45, the target base station 6-03 may transmit a handover request acknowledge to the source base station 6-02. The message may include new RRC configuration information.

During the handover preparation procedure, the source base station 6-02 may forward the segmented RRC message received from the terminal to the target base station 6-03. Specifically, according to at least one of the following options or a combination thereof, the source base station 6-02 may forward the segmented RRC message received from the terminal through a specific SRB or through a plurality of SRBs to the target base station 6-03.
Option 1: Predefine which SRB the segmented RRC message received through is forwarded by the source base station to the target base station (SRBs for which segments are forwarded can be predefined).
Option 2: The source base station forwards the segmented RRC messages received for all SRBs to the target base station (Segments of all SRBs are forwarded).
Option 3: Negotiate which SRB(s) the segmented RRC message received through is forwarded by the source base station to the target base station (SRBs for which segments are forwarded can be negotiated between source and target).
Option 4: At least one of the above options is applied, but in fact, predefine or negotiate in which SRB a specific RRC message is forwarded by the source base station to the target base station.

The new RRC configuration information included in the handover request acknowledge may include an indicator for RRC segment continuity using at least one of the following methods or a combination thereof.
Method 1: Indicator that RRC segment continuity is commonly applied to all SRBs (Indication can be common for all SRBs).
Method 2: Indicator indicating whether to apply RRC segmentation continuity for each SRB (Indication can be signaled per SRB).
Method 3: If an indicator is included, RRC segmentation continuity may be applied to pre-defined SRB(s) (Indication if present can be applicable for a pre-defined SRB).

In operation 6-50, the base station 6-02 may transmit an RRC message including a handover command to the terminal 6-01 to handover to the target base station (or target cell) 6-03. This may refer to the information received in operation 6-45. As an example, the RRC message may refer to an RRCReconfiguration message including reconfiguration WithSync or MobilityFromNRCommand.

In operation 6-55, when the terminal 6-01 performs a random access procedure to the target base station (or target cell) 6-03 and successfully performs a handover (or successfully completes the random access procedure), the terminal 6-01 may transmit an RRC message (e.g., RRCReconfigurationComplete) indicating successful completion of the random access procedure and handover to the target base station (or target cell) 6-03. The message may include information on the ULDedicatedMessageSegment message to be transmitted from the terminal 6-01 to the target base station (or target cell) 6-03. For example, the message may include information on at least one of: which segmented UL ULDedicatedMessageSegment message is (successfully) transmitted by the terminal 6-01 to the source base station 6-02, how many segments are (successfully) transmitted, how many segmented ULDedicatedMessageSegments are left, or what is the ULDedicatedMessageSegment corresponding to lastSegment.

In operation 6-60, the target base station 6-03 may transmit a message (e.g., a new RRC message, MAC CE, a previously defined RRC message, or a status report) to request the terminal 6-01 for a ULDedicatedMessageSegment that is missed or not stored. For example, the message may refer to a status report for an RRC segment. The message may include an SRB Id. For example, a status report for one or a plurality of SRBs may be included. The status report may include information on which segmented ULDedicatedMessageSegment message the terminal 6-01 should transmit first to the base station 6-03.

In operation 6-65, the terminal 6-01 may transmit ULDedicatedMessageSegment 2 set to segmentNumber=1 to the base station 6-03. In operation 6-66, the base station may store the received ULDedicatedMessageSegment 2.

In operation 6-70, the terminal 6-01 may transmit ULDedicatedMessageSegment 3 set to segmentNumber=2 to the base station 6-03. In operation 6-71, the base station may store the received ULDedicatedMessageSegment 3 in operation 6-71.

In operation 6-75, when receiving the ULDedicatedMessageSegment in which rrc-MessageSegmentType is set to lastSegment from the terminal 6-01, the base station 6-03 may concatenate the stored RRC segments and perform RRC decoding to derive the original RRC message.

According to embodiments of FIGS. 6A and 6B, when the terminal (successfully) transmits some of the segmented RRC messages to the source base station before performing the handover, the terminal may transmit to the target base station the segmented RRC message requested by the target base station that performs the handover. The terminal may determine whether to continuously transmit the segmented RRC message to the target base station according to the configurations of the target base station.

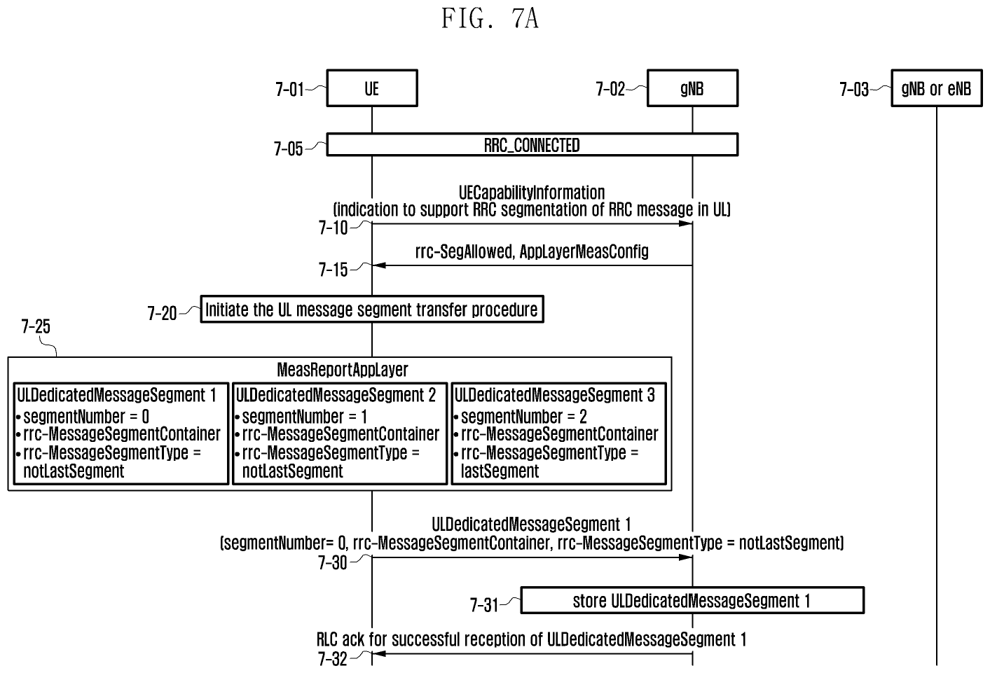

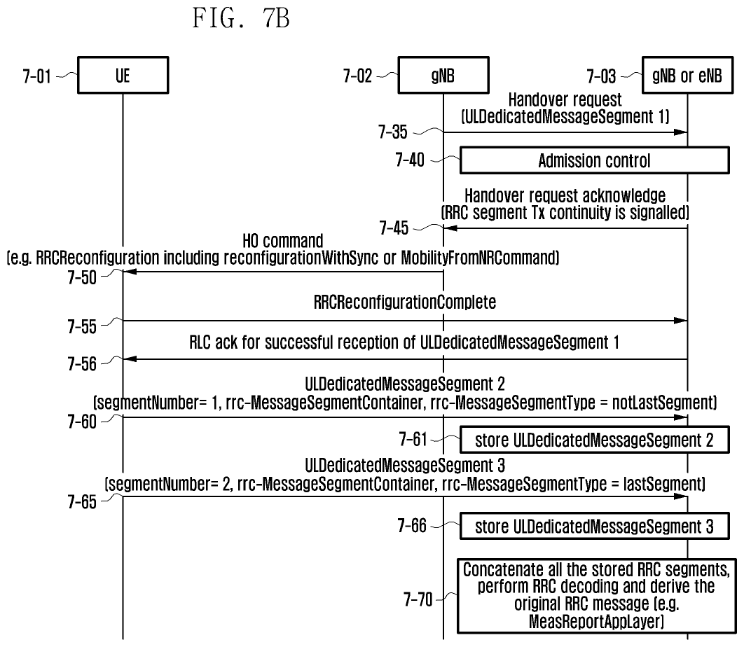

FIGS. 7A and 7B are flowcharts of a process in which a terminal transmits a segmented RRC message to a base station in a wireless communication system according to various embodiments of the disclosure.

The terminal according to the disclosure may transmit a segmented RRC message to the base station. When the size of an encoded RRC message is larger than the maximum supported size of a PDCP SDU, the terminal that is configured to allow RRC message segmentation (rrc-SegAllowed) from the base station may transmit a segmented RRC message to the base station through ULDedicatedMessageSegment. When a handover occurs, the terminal may perform transmission to the target cell, starting from the segmented RRC messages that are not (successfully) transmitted among the segmented RRC messages to the source cell, after handover. In the disclosure, the handover may refer to at least one of PCell change, PSCell addition or change, and PCell change and PSCell addition or change.

Referring to FIGS. 7A and 7B, in operation 7-05, a terminal 7-01 may establish an RRC connection with an NR base station 7-02 and be in the RRC connected mode (RRC_CONNECTED).

In operation 7-10, the terminal 7-01 may transmit a terminal capability information message (UECapabilityInformation) to the base station 7-02. Operation 7-10 may follow operations 5-10 and 6-10 described above. In addition, for the RRC message, the terminal capability information message may include capability information indicating that the terminal is able to transmit the RRC message after handover, starting from segmented RRC messages that are not (successfully) transmitted to the previous source cell. For example, the message may include capability information that the terminal may support RRC segment transmission continuity to the target cell even after handover.

In operation 7-15, the base station 7-02 may configure rrc-SegAllowed to the terminal 7-01 through an RRC message. The RRC message may refer to an RRC connection reconfiguration message (RRCReconfiguration), an RRC connection resume message (RRCResume), or a UE capability enquiry message (UECapabilityEnquiry). In the disclosure, for convenience of description, the RRC message may include configuration information (AppLayerMeasConfig) for application layer measurement.

In operation 7-20, the terminal 7-01 may initiate a UL message segment transfer procedure to transmit the application measurement result to the base station 7-02. For example, when the size of the encoded RRC message to be transmitted by the terminal is larger than the maximum supported size of one PDCP SDU, and when it is configured by the base station that the RRC message segmentation is enabled, the terminal may initiate the UL message segment transfer procedure.

In operation 7-25, the terminal 7-01 may segment an RRC message (e.g., a MeasurementReportAppLayer message) to be transmitted according to operations 5-25 and 6-25 described above to set the content of the ULDedicatedMessageSegment message.

The terminal 7-01 may transmit (all) ULDedicatedMessageSegment messages for the segmented RRC message in operation 7-20 to the base station 7-02 in ascending order of segmentNumber. In operation 7-30, the terminal may successfully transmit ULDedicatedMessageSegment 1 set to segmentNumber=0 to the base station 7-02. In operation 7-31, the base station 7-02 may store the received ULDedicatedMessageSegment 1. In operation 7-32, the base station 7-02 may transmit an RLC ack to the terminal 7-01 to indicate that ULDedicatedMessageSegment 1 is successfully received.

The base station 7-02 may perform a handover preparation procedure with a target base station 7-03. In operation 7-35, the base station 7-02 may transmit a handover request message to perform handover preparation with the target base station 7-03. The message may include ULDedicatedMessageSegment 1 stored in operation 7-31. In operation 7-40, the target base station 7-03 may perform admission control. In operation 7-45, the target base station 7-03 may transmit a handover request acknowledge to the base station 7-02. The message may include new RRC configuration information.

During the handover preparation procedure, the base station 7-02 may forward the segmented RRC message received from the terminal to the target base station 7-03. Specifically, according to at least one of the following options or a combination thereof, the base station 7-02 may forward the segmented RRC message received from the terminal through a specific SRB or through a plurality of SRBs to the target base station 7-03.
Option 1: Predefine which SRB the segmented RRC message received through is forwarded by the source base station to the target base station (SRBs for which segments are forwarded can be predefined).
Option 2: The source base station forwards the segmented RRC messages received for all SRBs to the target base station (Segments of all SRBs are forwarded).
Option 3: Negotiate which SRB(s) the segmented RRC message received through is forwarded by the source base station to the target base station (SRBs for which segments are forwarded can be negotiated between source and target).
Option 4: At least one of the above options is applied, but in fact, predefine or negotiate in which SRB a specific RRC message is forwarded by the source base station to the target base station.

The new RRC configuration information included in the handover request acknowledge may include an indicator for RRC segment continuity using at least one of the following methods or a combination thereof.
Method 1: Indicator that RRC segment continuity is commonly applied to all SRBs (Indication can be common for all SRBs).
Method 2: Indicator indicating whether to apply RRC segmentation continuity for each SRB (Indication can be signaled per SRB).
Method 3: If an indicator is included, RRC segmentation continuity may be applied to pre-defined SRB(s) (Indication if present can be applicable for a pre-defined SRB).

In operation 7-50, the base station 7-02 may transmit an RRC message including a handover command to the terminal 7-01 to handover to the target base station (or target cell) 7-03. This may refer to the information received in operation 7-45. As an example, the RRC message may refer to an RRCReconfiguration message including reconfiguration WithSync or MobilityFromNRCommand.

In operation 7-55, when the terminal 7-01 performs a random access procedure to the target base station (or target cell) 7-03 and successfully performs a handover (or successfully completes the random access procedure), the terminal 7-01 may transmit an RRC message (e.g., RRCReconfigurationComplete) indicating successful completion of the random access procedure and handover to the target base station (or target cell) 7-03. In operation 7-56, the target base station 7-03 may transmit an RLC ack to the terminal 7-01 to indicate that the target base station 7-03 has successfully received up to ULDedicatedMessageSegment 1 from the base station 7-02.

In operation 7-60, the terminal 7-01 may transmit to the target base station 7-03 the ULDedicatedMessage for which the RLC ack is not received. For example, the terminal 7-01 may transmit ULDedicatedMessageSegment 2 set to segmentNumber=1 to the target base station 7-03. In operation 7-61, the base station may store the received ULDedicatedMessageSegment 2.

In operation 7-65, the terminal 7-01 may transmit ULDedicatedMessageSegment 3 set to segmentNumber=2 to the target base station 7-03. In operation 7-66, the base station may store the received ULDedicatedMessageSegment 3.

In operation 7-70, when receiving the ULDedicatedMessageSegment in which rrc-MessageSegmentType is set to lastSegment from the terminal 7-01, the target base station 7-03 may concatenate the stored RRC segments and perform RRC decoding to derive the original RRC message.

According to embodiments of FIGS. 7A and 7B, when the terminal (successfully) transmits some of the segmented RRC messages to the source base station before performing the handover, the terminal may transmit to the target base station the segmented RRC message requested by the target base station that performs the handover. The terminal may determine whether to continuously transmit the segmented RRC message to the target base station according to the configurations of the target base station.

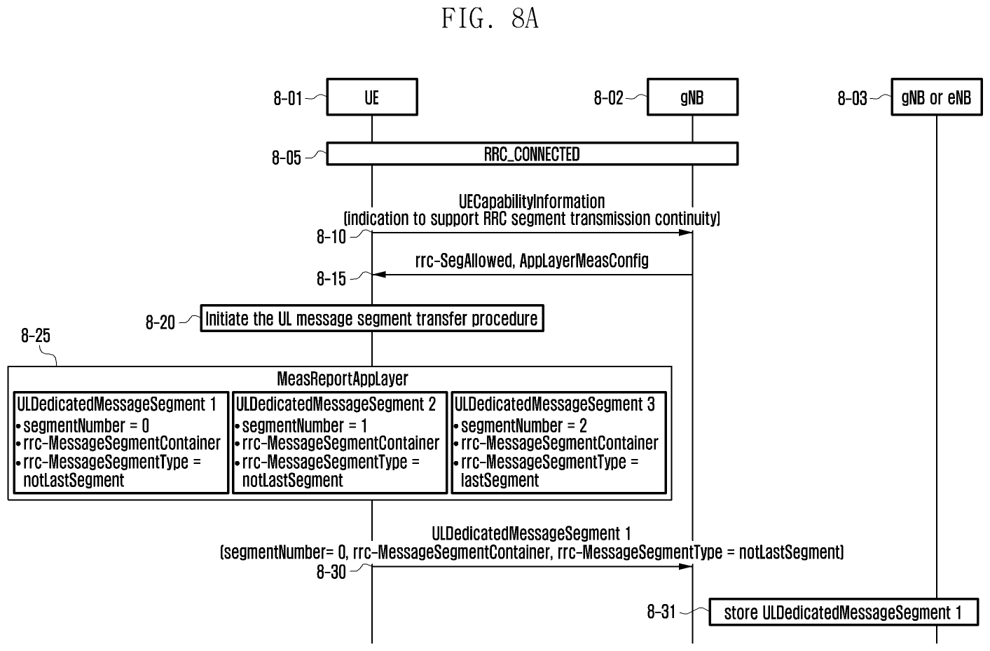

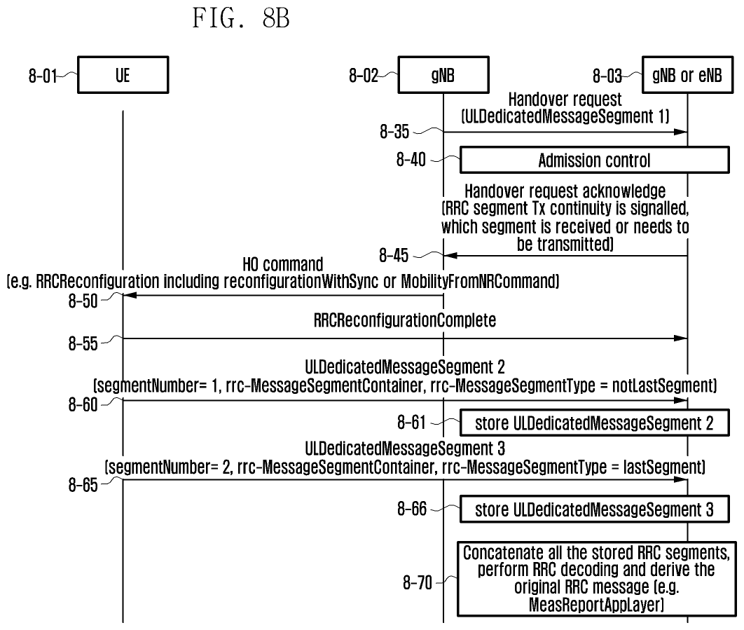

FIGS. 8A and 8B are flowcharts of a process in which a terminal transmits a segmented RRC message to a base station in a wireless communication system according to various embodiments of the disclosure.

The terminal according to the disclosure may transmit a segmented RRC message to the base station. When the size of an encoded RRC message is larger than the maximum supported size of a PDCP SDU, the terminal that is configured to allow RRC message segmentation (rrc-SegAllowed) from the base station may transmit a segmented RRC message to the base station through ULDedicatedMessageSegment. When a handover occurs, the terminal may perform transmission to the target cell, starting from the segmented RRC messages that are not (successfully) transmitted among the segmented RRC messages to the source cell, after handover. In the disclosure, the handover may refer to at least one of PCell change, PSCell addition or change, and PCell change and PSCell addition or change.

Referring to FIGS. 8A and 8B, in operation 8-05, a terminal 8-01 may establish an RRC connection with an NR base station 8-02 and be in the RRC connected mode (RRC_CONNECTED).

In operation 8-10, the terminal 8-01 may transmit a terminal capability information message (UECapabilityInformation) to the base station 8-02. Operation 8-10 may follow operations 5-10, 6-10, and 7-10 described above. In addition, for the RRC message, the terminal capability information message may include capability information indicating that the terminal is able to transmit the RRC message after handover, starting from segmented RRC messages that are not (successfully) transmitted to the previous source cell. For example, the message may include capability information that the terminal may support RRC segment transmission continuity to the target cell even after handover.

In operation 8-15, the base station 8-02 may configure rrc-SegAllowed to the terminal 8-01 through an RRC message. The RRC message may refer to an RRC connection reconfiguration message (RRCReconfiguration), an RRC connection resume message (RRCResume), or a UE capability enquiry message (UECapabilityEnquiry). In the disclosure, for convenience of description, the RRC message may include configuration information (AppLayerMeasConfig) for application layer measurement.

In operation 8-20, the terminal 8-01 may initiate a UL message segment transfer procedure to transmit the application measurement result to the base station 8-02. For example, when the size of the encoded RRC message to be transmitted by the terminal is larger than the maximum supported size of one PDCP SDU, and when it is configured by the base station that the RRC message segmentation is enabled, the terminal may initiate the UL message segment transfer procedure.

In operation 8-25, the terminal 8-01 may segment an RRC message (e.g., a MeasurementReportAppLayer message) to be transmitted according to operations 5-25, 6-25, and 7-25 described above to set the content of the ULDedicatedMessageSegment message.

The terminal 8-01 may transmit (all) ULDedicatedMessageSegment messages for the segmented RRC message in operation 8-20 to the base station 8-02 in ascending order of segmentNumber. In operation 8-30, the terminal may successfully transmit ULDedicatedMessageSegment 1 set to segmentNumber=0 to the base station 8-02. In operation 8-31, the base station 8-02 may store the received ULDedicatedMessageSegment 1.

The base station 8-02 may perform a handover preparation procedure with a target base station 8-03. In operation 8-35, the base station 8-02 may transmit a handover request message to perform handover preparation with the target base station 8-03. The message may include ULDedicatedMessageSegment 1 stored in operation 8-31. In operation 8-40, the target base station 8-03 may perform admission control. In operation 8-45, the target base station 8-03 may transmit a handover request acknowledge to the base station 8-02. The message may include new RRC configuration information.

During the handover preparation procedure, the base station 8-02 may forward the segmented RRC message received from the terminal to the target base station 8-03. Specifically, according to at least one of the following options or a combination thereof, the base station 8-02 may forward the segmented RRC message received from the terminal through a specific SRB or through a plurality of SRBs to the target base station 8-03.
Option 1: Predefine which SRB the segmented RRC message received through is forwarded by the source base station to the target base station (SRBs for which segments are forwarded can be predefined).
Option 2: The source base station forwards the segmented RRC messages received for all SRBs to the target base station (Segments of all SRBs are forwarded).
Option 3: Negotiate which SRB(s) the segmented RRC message received through is forwarded by the source base station to the target base station (SRBs for which segments are forwarded can be negotiated between source and target).
Option 4: At least one of the above options is applied, but in fact, predefine or negotiate in which SRB a specific RRC message is forwarded by the source base station to the target base station.

The new RRC configuration information included in the handover request acknowledge may include an indicator for RRC segment continuity using at least one of the following methods or a combination thereof.
Method 1: Indicator that RRC segment continuity is commonly applied to all SRBs (Indication can be common for all SRBs).
Method 2: Indicator indicating whether to apply RRC segmentation continuity for each SRB (Indication can be signaled per SRB).
Method 3: If an indicator is included, RRC segmentation continuity may be applied to pre-defined SRB(s) (Indication if present can be applicable for a pre-defined SRB).

In addition, the handover request acknowledge may include information regarding which segmented RRC segment is successfully received and/or from which segmented RRC segment the terminal should transmit.

This method may reduce the possibility of RRC segments being lost. For example, it is assumed that the terminal 8-01 transmits ULDedicatedMessageSegment 1 and ULDedicatedMessageSegment 2 to the base station 8-02, and the base station 8-02 transmits an RLC ack to the terminal 8-01 that the source base station has received well up to ULDedicatedMessageSegment 2. In this case, the base station 8-02 may only forward up to ULDedicatedMessageSegment 1 to the target base station 8-03.

Accordingly, when the terminal transmits ULDedicatedMessageSegment 3 to the target base station 8-03, ULDedicatedMessageSegment 2 may be lost because the target base station 8-03 has not actually received ULDedicatedMessageSegment 2 from the base station 8-02. In order to address the above issue, information, indicating that the target base station (or target cell) 8-03 successfully receives up to ULDedicatedMessageSegment 1 and/or that the terminal should transmit messages starting from ULDedicatedMessageSegment 2, may be included in the handover request acknowledge. When the information is forwarded to the terminal 8-01 through the handover command message, the terminal 8-01 may transmit to the target base station 8-03 starting from ULDedicatedMessageSegment 2.

In operation 8-50, the base station 8-02 may transmit an RRC message including a handover command to the terminal 8-01 to handover to the target base station (or target cell) 8-03. This may refer to the information received in operation 8-45. As an example, the RRC message may refer to an RRCReconfiguration message including reconfiguration WithSync or MobilityFromNRCommand.

In operation 8-55, when the terminal 8-01 performs a random access procedure to the target base station (or target cell) 8-03 and successfully performs a handover (or successfully completes the random access procedure), the terminal 8-01 may transmit an RRC message (e.g., RRCReconfigurationComplete) indicating successful completion of the random access procedure and handover to the target base station (or target cell) 8-03.

In operation 8-60, the terminal 8-01 may transmit a specific ULDedicatedMessageSegment message to the target base station 8-03 based on the information (for example, information on which of the RRC segments the target base station 8-03 has successfully received and/or which of the RRC segments the terminal 8-01 should transmit first) received through operation 8-50. For example, the terminal 8-01 may transmit ULDedicatedMessageSegment 2 set to segmentNumber=1 to the target base station 8-03. In operation 8-61, the base station may store the received ULDedicatedMessageSegment 2.

In operation 8-65, the terminal 8-01 may transmit ULDedicatedMessageSegment 3 set to segmentNumber=2 to the target base station 8-03. In operation 8-66, the base station may store the received ULDedicatedMessageSegment 3.

In operation 8-70, when receiving the ULDedicatedMessageSegment in which rrc-MessageSegmentType is set to lastSegment from the terminal 8-01, the target base station 8-03 may concatenate the stored RRC segments and perform RRC decoding to derive the original RRC message.

According to embodiments of FIGS. 8A and 8B, when the terminal (successfully) transmits some of the segmented RRC messages to the source base station before performing the handover, the terminal may transmit to the target base station the segmented RRC message requested by the target base station that performs the handover. Here, after handover, for RRC segments mapped to specific use cases (e.g., application measurements for QoE), the terminal may not transmit RRC segments failed to be (successfully) transmitted to the target base station. This is because the terminal successfully transmitted important information to the base station through a previous RRC segmented message, so relatively unimportant information may not be transmitted. In addition, the terminal may determine whether to continuously transmit the segmented RRC message to the target base station according to the configurations of the target base station.

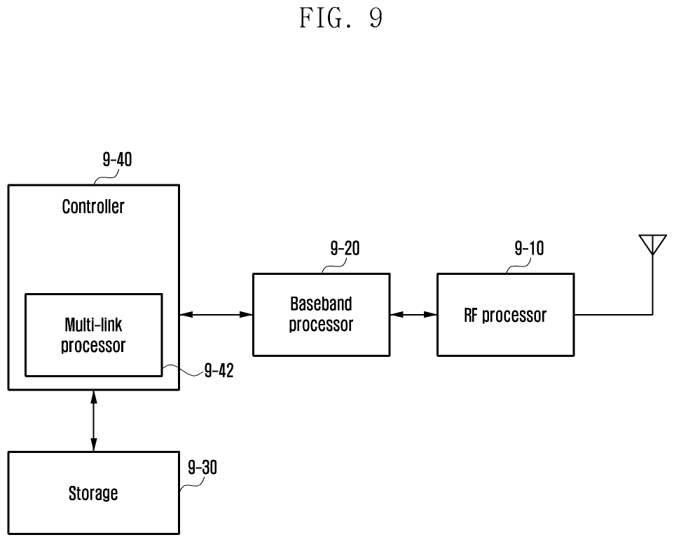

FIG. 9 is a block diagram illustrating the internal structure of a terminal according to an embodiment of the disclosure.

Referring to FIG. 9, the terminal includes a radio frequency (RF) processor 9-10, a baseband processor 9-20, a storage 9-30, and a controller 9-40.

The RF processor 9-10 performs a function for transmitting and receiving a signal through a radio channel, such as band conversion and amplification of a signal. For example, the RF processor 9-10 up-converts a baseband signal provided from the baseband processor 9-20 into an RF band signal, transmits the RF band signal through an antenna, and down-converts the RF band signal received through the antenna to the baseband signal. For example, the RF processor 9-10 may include a transmission filter, a reception filter, an amplifier, a mixer, an oscillator, a digital to analog converter (DAC), an analog to digital converter (ADC), or the like. In the diagram, only one antenna is illustrated, but the terminal may include a plurality of antennas. In addition, the RF processor 9-10 may include a plurality of RF chains. Furthermore, the RF processor 9-10 may perform beamforming. For the beamforming, the RF processor 9-10 may adjust the phase and magnitude of each of signals transmitted and received through a plurality of antennas or antenna elements. In addition, the RF processor may perform MIMO, and may receive multiple layers when performing the MIMO operation.

The baseband processor 9-20 performs a function of converting between a baseband signal and a bit stream according to a physical layer standard of the system. For example, when transmitting data, the baseband processor 9-20 generates complex symbols by encoding and modulating a transmitted bit stream. In addition, when receiving data, the baseband processor 9-20 restores a received bit stream by demodulating and decoding the baseband signal provided from the RF processor 9-10. For example, in the case of following an orthogonal frequency division multiplexing (OFDM) scheme, when transmitting data, the baseband processor 9-20 generates complex symbols by encoding and modulating a transmitted bit stream, maps the complex symbols to subcarriers, and then configures OFDM symbols through an inverse fast Fourier transform (IFFT) calculation and cyclic prefix (CP) insertion. In addition, when receiving data, the baseband processor 9-20 segments the baseband signal provided from the RF processor 9-10 into OFDM symbol units, restores signals mapped to subcarriers through a fast Fourier transform (FFT), and then restores a received bit stream through demodulation and decoding.

The baseband processor 9-20 and the RF processor 9-10 transmits and receives signals as described above. Accordingly, the baseband processor 9-20 and the RF processor 9-10 may be referred to as a transmitter, a receiver, a transceiver, or a communicator. Furthermore, at least one of the baseband processor 9-20 and the RF processor 9-10 may include a plurality of communication modules to support a plurality of different radio access technologies. In addition, at least one of the baseband processor 9-20 and the RF processor 9-10 may include different communication modules to process signals of different frequency bands. For example, the different radio access technologies may include a wireless local area network (LAN) (e.g., institute of electrical and electronics engineers (IEEE) 802.11), a cellular network (e.g., LTE), or the like. In addition, the different frequency bands may include a super high frequency (SHF) (e.g., 2.NRHz, NRhz) band and a millimeter wave (e.g., 60 GHZ) band.

The storage 9-30 stores data, such as a basic program, an application program, and configuration information for the operation of the terminal. In addition, the storage 9-30 provides stored data according to the request of the controller 9-40.

The controller 9-40 may include a multi-link processor 9-42 and controls overall operations of the terminal. The controller 9-40 may control the terminal according to at least one or a combination of methods corresponding to the above-described embodiments. For example, the controller 9-40 transmits and receives signals through the baseband processor 9-20 and the RF processor 9-10. In addition, the controller 9-40 writes data in the storage 9-30 and reads the data. To this end, the controller 9-40 may include at least one processor. For example, the controller 9-40 may include a communication processor (CP) that controls for communication and an application processor (AP) that controls an upper layer, such as an application program.

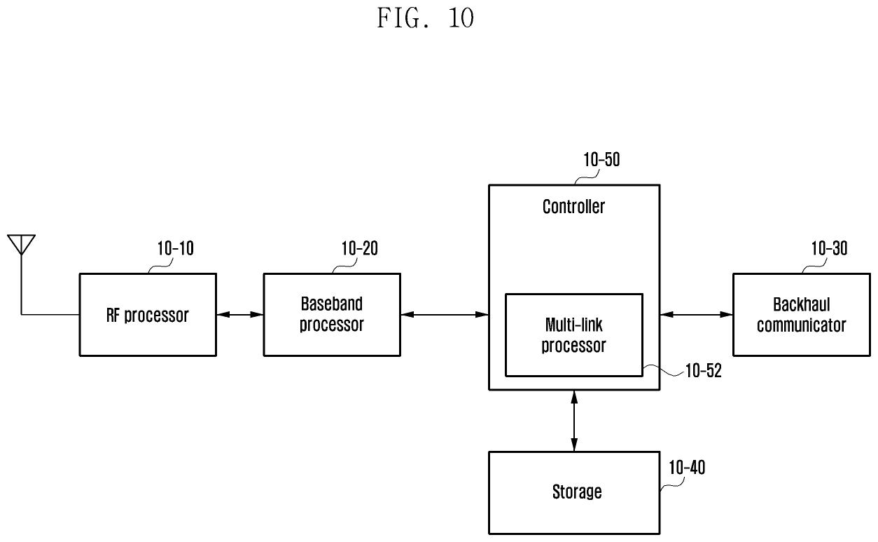

FIG. 10 is a block diagram illustrating the configuration of an NR base station according to an embodiment of the disclosure.

Referring to FIG. 10, the base station is configured including an RF processor 10-10, a baseband processor 10-20, a backhaul communicator 10-30, a storage 10-40, and a controller 10-50.

The RF processor 10-10 performs a function for transmitting and receiving a signal through a radio channel, such as band conversion and amplification of the signal. For example, the RF processor 10-10 up-converts the baseband signal provided from the baseband processor 10-20 into an RF band signal, transmits the same through an antenna, and down-converts the RF band signal received through the antenna into a baseband signal. For example, the RF processor 10-10 may include a transmission filter, a reception filter, an amplifier, a mixer, an oscillator, a DAC, an ADC, and the like. Although only one antenna is illustrated in the diagram, the NR base station may include a plurality of antennas. In addition, the RF processor 10-10 may include a plurality of RF chains. Furthermore, the RF processor 10-10 may perform beamforming. For the beamforming, the RF processor 10-10 may adjust the phase and magnitude of each of signals transmitted and received through a plurality of antennas or antenna elements. The RF processor may perform a downlink MIMO operation by transmitting one or more layers.

The baseband processor 10-20 performs a function of converting between a baseband signal and a bit stream according to the physical layer standard of the first radio access technology. For example, when transmitting data, the baseband processor 10-20 generates complex symbols by encoding and modulating a transmitted bit stream. In addition, when receiving data, the baseband processor 10-20 restores a received bit stream through demodulating and decoding the baseband signal provided from the RF processor 10-10. For example, in the case of following the OFDM scheme, when transmitting data, the baseband processor 10-20 generates complex symbols by encoding and modulating a transmitted bit stream, maps the complex symbols to subcarriers, and then configures OFDM symbols through IFFT calculation and CP insertion. In addition, when receiving data, the baseband processor 10-20 segments the baseband signal provided from the RF processor 10-10 into OFDM symbol units, restores signals mapped to subcarriers through FFT calculation, and then restores a received bit stream through demodulation and decoding. The baseband processor 10-20 and the RF processor 10-10 transmits and receives signals as described above. Accordingly, the baseband processor 10-20 and the RF processor 10-10 may be referred to as a transmitter, a receiver, a transceiver, a communicator, or a wireless communicator.

The backhaul communicator 10-30 provides an interface for performing communication with other nodes in the network. For example, the backhaul communicator 10-30 converts a bit stream transmitted from the main base station to another node, for example, an auxiliary base station, a core network, or the like, into a physical signal, and converts a physical signal received from the other node into a bit stream.

The storage 10-40 stores data, such as a basic program, an application program, and configuration information for the operation of the main base station. More particularly, the storage 10-40 may store information on a bearer allocated to an accessed terminal, a measurement result reported from the accessed terminal, and the like. In addition, the storage 10-40 may store information serving as a criterion for determining whether to provide or stop multiple connections to the terminal. In addition, the storage 10-40 provides stored data according to the request of the controller 10-50.

The controller 10-50 may include a multi-link processor 10-52 and controls overall operations of the main base station. The controller 10-50 may control the base station according to at least one or a combination of methods corresponding to the above-described embodiments. For example, the controller 10-50 transmits and receives signals through the baseband processor 10-20 and the RF processor 10-10 or through the backhaul communicator 10-30. In addition, the controller 10-50 writes data in the storage 10-40 and reads the data. To this end, the controller 10-50 may include at least one processor.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
transmitting, to a first base station, a first segment of a radio resource control (RRC) message;
receiving, from the first base station, a handover command message;
performing a handover to a second base station based on the handover command message;
transmitting, to the second base station, an RRC reconfiguration complete message; and
transmitting, to the second base station, a second segment of the RRC message.

2. The method of claim 1,
wherein the RRC reconfiguration complete message includes information indicating at least one of:
one or more segments of the RRC message that have been successfully transmitted to the first base station,
a number of segments of the RRC message that have been successfully transmitted to the first base station,
a number of segments of the RRC message that remain to be transmitted, or
a last segment of the RRC message, and
wherein transmitting the RRC reconfiguration complete message further comprises receiving, from the second base station, a status report message including a signaling radio bearer (SRB) identifier associated with the RRC message and information on one or more requested segments of the RRC message.

3. The method of claim 1, wherein the second segment of the RRC message is transmitted, in case that a radio link control (RLC) acknowledgement for the second segment of the RRC message has not been received.

4. The method of claim 1, wherein the handover command message includes information indicating that the first segment of the RRC message has been successfully received or that the second segment of the RRC message is required to be transmitted.

5. The method of claim 1, wherein the handover command message includes information indicating that continuity of RRC segmentation is allowed for all signaling radio bearers (SRBs), individually for each SRB, or all of one or more pre-defined SRBs.

6. A method performed by a second base station in a wireless communication system, the method comprising:
receiving, from a first base station, a handover request message including a first segment of a radio resource control (RRC) message associated with a terminal;
transmitting, to the first base station, a handover request acknowledgement message;
after a handover of the terminal to the second base station, receiving, from the terminal an RRC reconfiguration complete message; and
receiving, from the terminal, a second segment of the RRC message.

7. The method of claim 6,
wherein the RRC reconfiguration complete message includes information indicating at least one of:
one or more segments of the RRC message that have been successfully transmitted to the first base station,
a number of segments of the RRC message that have been successfully transmitted to the first base station,
a number of segments of the RRC message that remain to be transmitted, or
a last segment of the RRC message, and
wherein receiving the RRC reconfiguration complete message further comprises transmitting, to the terminal, a status report message including a signaling radio bearer (SRB) identifier associated with the RRC message and information on one or more requested segments of the RRC message.

8. The method of claim 6, wherein the second segment of the RRC message is received, in case that a radio link control (RLC) acknowledgement for the second segment of the RRC message has not been transmitted.

9. The method of claim 6, wherein the handover request acknowledgement message includes information indicating that the first segment of the RRC message has been successfully received or that the second segment of the RRC message is required to be transmitted.

10. The method of claim 6, wherein the handover request acknowledgement message includes information indicating that continuity of RRC segmentation is allowed for all signaling radio bearers (SRBs), individually for each SRB, or all of one or more pre-defined SRBs.

11. A terminal in a wireless communication system, the terminal comprising:
a transceiver; and
a controller coupled with the transceiver and configured to:
transmit, to a first base station, a first segment of a radio resource control (RRC) message,
receive, from the first base station, a handover command message,
perform a handover to a second base station based on the handover command message,
transmit, to the second base station, an RRC reconfiguration complete message, and
transmit, to the second base station, a second segment of the RRC message.

12. The terminal of claim 11,
wherein the RRC reconfiguration complete message includes information indicating at least one of:
one or more segments of the RRC message that have been successfully transmitted to the first base station,
a number of segments of the RRC message that have been successfully transmitted to the first base station,
a number of segments of the RRC message that remain to be transmitted, or
a last segment of the RRC message, and
wherein the controller is further configured to receive, from the second base station, a status report message including a signaling radio bearer (SRB) identifier associated with the RRC message and information on one or more requested segments of the RRC message.

13. The terminal of claim 11, wherein the second segment of the RRC message is transmitted, in case that a radio link control (RLC) acknowledgement for the second segment of the RRC message has not been received.

14. The terminal of claim 11, wherein the handover command message includes information indicating that the first segment of the RRC message has been successfully received or that the second segment of the RRC message is required to be transmitted.

15. The terminal of claim 11, wherein the handover command message includes information indicating that continuity of RRC segmentation is allowed for all signaling radio bearers (SRBs), individually for each SRB, or all of one or more pre-defined SRBs.

16. A second base station in a wireless communication system, the second base station comprising:
a transceiver; and
a controller coupled with the transceiver and configured to:
receive, from a first base station, a handover request message including a first segment of a radio resource control (RRC) message associated with a terminal,
transmit, to the first base station, a handover request acknowledgement message,
after a handover of the terminal to the second base station, receive, from the terminal an RRC reconfiguration complete message, and
receive, from the terminal, a second segment of the RRC message.

17. The second base station of claim 16,
wherein the RRC reconfiguration complete message includes information indicating at least one of:
one or more segments of the RRC message that have been successfully transmitted to the first base station,
a number of segments of the RRC message that have been successfully transmitted to the first base station,
a number of segments of the RRC message that remain to be transmitted, or
a last segment of the RRC message, and
wherein the controller is further configured transmit, to the terminal, a status report message including a signaling radio bearer (SRB) identifier associated with the RRC message and information on one or more requested segments of the RRC message.

18. The second base station of claim 16, wherein the second segment of the RRC message is received, in case that a radio link control (RLC) acknowledgement for the second segment of the RRC message has not been transmitted.

19. The second base station of claim 16, wherein the handover request acknowledgement message includes information indicating that the first segment of the RRC message has been successfully received or that the second segment of the RRC message is required to be transmitted.

20. The second base station of claim 16, wherein the handover request acknowledgement message includes information indicating that continuity of RRC segmentation is allowed for all signaling radio bearers (SRBs), individually for each SRB, or all of one or more pre-defined SRBs.
